(19) United States
(12) Patent Application Publication
(10) Pub. No.: US 2018/0120844 A1
(43) Pub. Date: May 3, 2018

(54) AUTONOMOUS DRIVING ASSISTANCE SYSTEM, AUTONOMOUS DRIVING ASSISTANCE METHOD, AND COMPUTER PROGRAM

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Takahiro OKAMOTO, Okazaki (JP); Saijiro TANAKA, Okazaki (JP); Kuniaki TANAKA, Nagoya (JP); Masaki TAKANO, Susono (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 15/565,785

(22) PCT Filed: Apr. 26, 2016
(86) PCT No.: PCT/JP2016/062992

§ 371 Date: Oct. 11, 2017

(30) Foreign Application Priority Data
Apr. 27, 2015 (JP) 2015-090225

(51) Int. Cl. G05D 1/00

(52) U.S. Cl. CPC G05D 1/0088; G05D 2201/0213; G05D 1/0061

(57) ABSTRACT

Autonomous driving assistance systems, methods, and programs determine if an execution restricted section is located ahead in a vehicle travel direction during autonomous driving assistance. If so, the systems, methods, and programs obtain required preliminary operation time that is based on a type of the execution restricted section. The systems, methods, and programs determine based on a vehicle speed and the required preliminary operation time, if time required to reach a start point of the execution restricted section is equal to or less than the required preliminary operation time. If so, the systems, methods, and programs determine if a vehicle state satisfies an executable condition under which autonomous driving assistance can be continued in the execution restricted section. If not, the systems, methods, and programs control the vehicle or prompt a user to shift the state of the vehicle to a state that satisfies the executable condition.

### TECHNICAL FIELD

Related technical fields include autonomous driving assistance systems, autonomous driving assistance methods, and computer programs which execute autonomous driving assistance for vehicles.

### BACKGROUND

In recent years, in addition to manual driving in which a vehicle travels based on user's driving maneuvers, a new drive mode has been proposed regarding autonomous driving assistance systems that assist the user in driving a vehicle by performing a part or all of user's driving maneuvers by the vehicle. For example, the autonomous driving assistance system autonomously performs vehicle control such as control of steering, a driving source, and a brake so as to keep the vehicle approximately centered in the same lane while maintaining a preset vehicle speed and a certain distance to a vehicle ahead. The autonomous driving assistance system is advantageous in that it eases the driving burden on the user. However, autonomous driving assistance cannot be executed everywhere. There are sections where autonomous driving assistance cannot be executed or where a certain condition must be satisfied in order to execute autonomous driving assistance (hereinafter referred to as the “execution restricted sections”).

For example, in sections having a curved shape, it is difficult to appropriately move a vehicle along the curved shape with autonomous driving assistance if the vehicle speed is high. Accordingly, the condition for executing autonomous driving assistance in such sections is that the vehicle speed is equal to or lower than the speed according to the radius of curvature of the curve. On the other hand, in sections where a lane marking or markings are missing or have faded so much that a camera cannot recognize them, it is difficult to move a vehicle with autonomous driving assistance if the vehicle speed is low, because a lane in which the vehicle should travel cannot be recognized for a long time. Accordingly, the condition for executing autonomous driving assistance in such sections is that the vehicle speed is equal to or higher than a predetermined speed. In sections where a plurality of roads connect such as merging points and intersections, autonomous driving assistance cannot be executed because the vehicle is required to behave flexibly according to surrounding circumstances.

Conventionally, when a vehicle travels in such an execution restricted section, the time required to make a transition from traveling with autonomous driving assistance to traveling by manual driving is calculated, and the user is prompted to make a transition to manual driving so that the transition from traveling with autonomous driving assistance to traveling by manual driving is completed before the vehicle reaches the execution restricted section, as disclosed in Japanese Patent No. 3239727.

### SUMMARY

The execution restricted sections include sections where autonomous driving assistance can be executed if a certain condition is satisfied, such as the curved sections and the sections where a lane marking or markings cannot be recognized as described above, in addition to sections where autonomous driving assistance can never be executed. In Japanese Patent No. 3239727, however, it is not determined if autonomous driving assistance can be executed in an execution restricted section located ahead in the direction in which the vehicle is traveling. Moreover, even if this section is a section where autonomous driving assistance can be executed if a certain condition is satisfied, neither the vehicle is controlled nor the user is prompted in order to satisfy the condition, but the user is always prompted to make a transition to manual driving. That is, in Japanese Patent No. 3239727, autonomous driving assistance is stopped without determining if autonomous driving assistance can be executed in an execution restricted section located ahead in the direction in which the vehicle is traveling. As a result, autonomous driving assistance is stopped even in a situation where autonomous driving assistance can be continued.

Exemplary embodiments of the broad inventive principles described herein solve the above conventional problem, and provide an autonomous driving assistance system, an autonomous driving assistance method, and a computer program, which allow autonomous driving assistance to be continued as long as possible even if there is an execution restricted section where execution of autonomous driving assistance is restricted.

Exemplary embodiments provide autonomous driving assistance systems, methods, and programs that determine if an execution restricted section is located ahead in a vehicle travel direction during autonomous driving assistance. If the execution restricted section is located ahead, the systems, methods, and programs obtain required preliminary operation time that is based on a type of the execution restricted section. The systems, methods, and programs determine based on a vehicle speed and the required preliminary operation time, if time required to reach a start point of the execution restricted section is equal to or less than the required preliminary operation time. If the time required to reach the start point is equal to or less than the required preliminary operation time, the systems, methods, and programs determine if a state of the vehicle satisfies an executable condition under which autonomous driving assistance can be continued in the execution restricted section. If it is determined that the state of the vehicle does not satisfy the executable condition in the execution restricted section, the systems, methods, and programs control the vehicle or prompt a user to shift the state of the vehicle to a state that satisfies the executable condition.

The term “autonomous driving assistance” refers to the function to perform at least a part of driver's vehicle maneuvers on behalf of the driver or to assist the driver with at least a part of driver's vehicle maneuvers.

The expression “execution of autonomous driving assistance is restricted” includes the state where a certain condition must be satisfied in order to execute autonomous driving assistance, in addition to the state where a part or all of autonomous driving assistance cannot be executed.

According to the autonomous driving assistance system, the autonomous driving assistance method, and the computer program which have the above configuration, even if an execution restricted section where execution of autonomous driving assistance is restricted is located ahead in the direction in which the vehicle is traveling, the vehicle is controlled or the user is prompted according to the current state of the vehicle at such a timing that allows necessary and sufficient time before the vehicle reaches the execution restricted section. Accordingly, by the time the vehicle reaches the execution restricted section, the state of the vehicle can be shifted to the state where autonomous driving assistance can be executed. As a result, autonomous driving assistance can be continued as long as possible.

### BRIEF DESCRIPTION OF THE DRAWINGS

FIG. 1 is a block diagram showing the configuration of a navigation system according to an embodiment.

FIG. 2 is a diagram showing an example of a storage area of an execution restricted section DB.

FIG. 3 is a diagram showing an example of an execution restricted section.

FIG. 4 is a diagram showing an example of an execution restricted section.

FIG. 5 is a diagram showing an example of an execution restricted section.

FIG. 6 is a diagram showing an example of a preliminary operation correspondence table.

FIG. 7 is a flowchart of an autonomous driving assistance program according to the embodiment.

FIG. 8 is a diagram illustrating the case where the user is prompted to make a transition to manual driving.

FIG. 9 is a diagram showing an example of how to inform the user of the position of the start point of an execution restricted section.

FIG. 10 is a diagram showing an example of how to inform the user of the fact that his/her vehicle is located in an execution restricted section.

FIG. 11 is a diagram illustrating how the vehicle is controlled after the vehicle satisfies an executable condition.

FIG. 12 is a diagram illustrating how the user is prompted or the vehicle is controlled particularly when a curved section is present as an execution restricted section.

FIG. 13 is a diagram illustrating how the user is prompted or the vehicle is controlled particularly when a section where a lane marking or markings cannot be recognized is present as an execution restricted section.

### DETAILED DESCRIPTION OF EXEMPLARY EMBODIMENTS

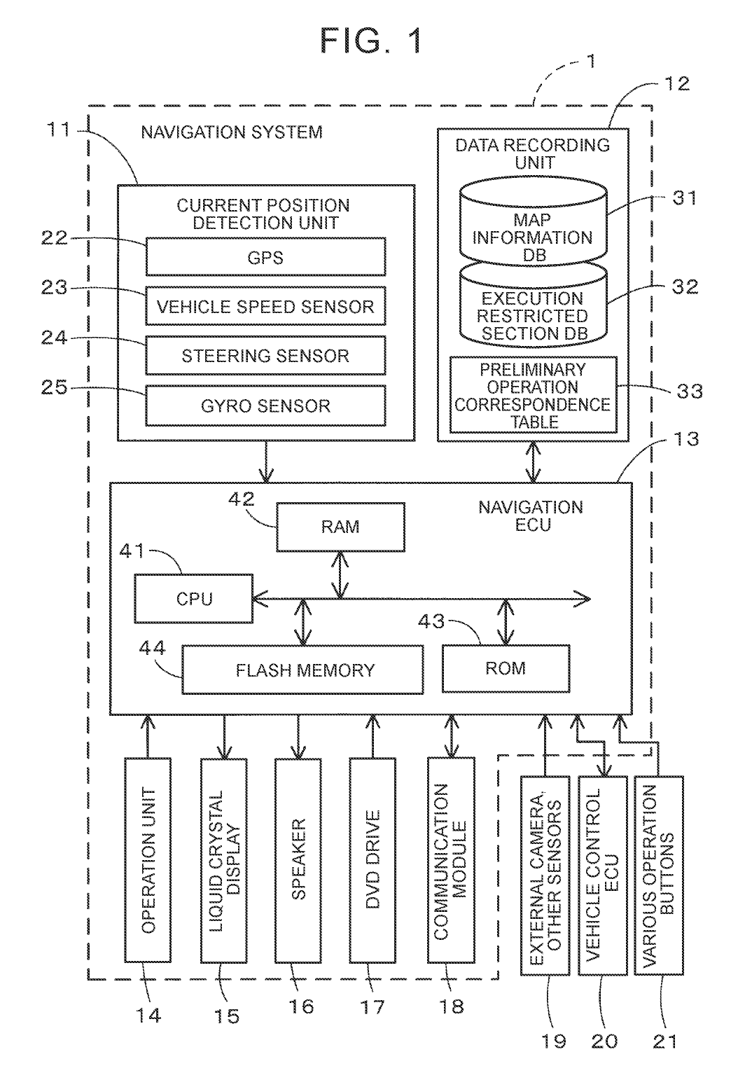

An autonomous driving assistance system will be described in detail below based on an embodiment of a navigation system with reference to the accompanying drawings. First, the general configuration of a navigation system 1 according to an embodiment will be described with reference to FIG. 1. FIG. 1 is a block diagram of the navigation system 1 according to the embodiment.

As shown in FIG. 1, the navigation system 1 according to the embodiment is comprised of: a current position detection unit 11 that detects the current position of a vehicle equipped with the navigation system 1; a data recording unit 12 having various data recorded thereon; a navigation ECU 13 that performs various arithmetic operations based on received information; an operation unit 14 that accepts user's operations; a liquid crystal display 15 that displays to the user a map around the vehicle, information about a guidance route set by the navigation system 1 (a planned travel route to be taken by the vehicle), etc.; a speaker 16 that outputs voice guidance about the route; a DVD drive 17 that reads a DVD serving as a storage medium; and a communication module 18 that communicates with an information center such as a probe center or a Vehicle Information and Communication System (VICS (registered trademark)) center. (As used herein, the term “storage medium” is not intended to encompass transitory signals). An external camera 19 and various sensors, which are mounted on the vehicle equipped with the navigation system 1, are connected to the navigation system 1 via an in-vehicle network such as a CAN. A vehicle control ECU 20 that performs various controls of the vehicle equipped with the navigation system 1 is also connected to the navigation system 1 so that the navigation system 1 and the vehicle control ECU 20 can communicate bidirectionally with each other. Various operation buttons 21 mounted on the vehicle, such as an autonomous driving start button, are also connected to the navigation system 1.

The components of the navigation system 1 will be sequentially described below.

The current position detection unit 11 is comprised of a GPS 22, a vehicle speed sensor 23, a steering sensor 24, a gyro sensor 25, etc. and can detect the current position and bearing of the vehicle, the traveling speed of the vehicle, the current time, etc. In particular, the vehicle speed sensor 23 is a sensor that detects the distance traveled by the vehicle and the vehicle speed. The vehicle speed sensor 23 generates pulses according to rotation of drive wheels of the vehicle and outputs pulse signals to the navigation ECU 13. The navigation ECU 13 counts the number of generated pulses to calculate the rotational speed of the drive wheels and the traveled distance. The navigation system 1 need not necessarily include all of these four sensors. The navigation system 1 may include only one or more of these sensors.

The data recording unit 12 includes a hard disk (not shown) serving as an external storage device and a recording medium, and a recording head (not shown) serving as a driver for reading a map information DB 31, an execution restricted section DB 32, a preliminary operation correspondence table 33, predetermined programs, etc., which are recorded on the hard disk, and writing predetermined data on the hard disk. The data recording unit 12 may be comprised of a flash memory, a memory card, or an optical disk such as a CD or a DVD instead of the hard disk. The map information DB 31, the execution restricted section DB 32, and the preliminary operation correspondence table 33 may be stored in an external server, and the navigation system 1 may obtain the map information DB 31, the execution restricted section DB 32, and the preliminary operation correspondence table 33 by communication with the external server.

The map information DB 31 is storage means having stored therein, e.g., link data regarding roads (links), node data regarding node points, search data that is used for processing associated with route searches and route changes, facility data regarding facilities, map display data for displaying a map, intersection data regarding intersections, search data for searching for locations, etc.

The link data includes: regarding links of roads, data indicating the width, gradient, cant, and bank of the road to which the link belongs, the road surface condition, a merging section, the road structure, the number of lanes of the road, a location where the number of lanes decreases, a location where the road narrows, a railroad crossing, etc.; regarding corners, data indicating the radius of curvature, an intersection, a T-junction, the entrance and exit of the corner, etc.; regarding road attributes, data indicating a downhill road, an uphill road, etc.; and regarding road types, data indicating a local road such as a national road, a prefectural road, or a narrow street, and a toll road such as a national expressway, an urban expressway, an automobile road, a local toll road, or a toll bridge.

The node data includes data regarding the coordinates (positions) of node points that are set at branch points (including intersections, T-junctions, etc.) of actual roads and that are set at predetermined intervals on each road according to the radius of curvature etc., node attributes indicating whether the node is a node corresponding to an intersection or not etc., a connection link number list that is a list of link numbers of links connecting to the node, an adjacent node number list that is a list of node numbers of nodes each located adjacent to the node with a link therebetween, the height (altitude) of each node point, etc.

The execution restricted section DB 32 is stored regarding execution restricted sections where execution of autonomous driving assistance is restricted for roads all over the country.

Drive modes of the vehicle include driving with autonomous driving assistance in which the vehicle autonomously travels along a preset route or along the road without user's driving maneuvers, in addition to manual driving in which the vehicle travels based on user's driving maneuvers. For example, in driving with autonomous driving assistance, the current position of the vehicle, the current lane of the vehicle, and the position of other traffic around the vehicle are detected as needed, and the vehicle control ECU 20 autonomously performs vehicle control such as control of steering, a driving source, and a brake so that the vehicle travels along a preset route or along the road. In driving with autonomous driving assistance of the present embodiment, neither lane changes nor right and left turns are made, and the vehicle basically travels in the same lane unless the user performs vehicle maneuvers for a lane change or a right or left turn.

In the present embodiment, the following three types of autonomous driving assistance are particularly executed.

(1) “Constant speed cruising” . . . The vehicle is controlled to travel in the same lane at a predetermined set speed (e.g., 90% of the speed limit of a road on which the vehicle is traveling).

(2) “Adaptive cruising” . . . The vehicle is controlled to travel in the same lane at up to a set speed (e.g., 90% of the speed limit of a road on which the vehicle is traveling) while maintaining a certain distance (e.g., 10 m) to a vehicle ahead.

(3) “Lane keeping” . . . The vehicle is kept approximately centered in the lane without causing lane deviation (e.g., lane keeping assistance).

The controls (1) to (3) for autonomous driving assistance may be performed either in all road sections or only when the vehicle is traveling on a freeway having gates (either manned or unmanned, and either toll or toll-free) at boundaries with other roads connecting to the freeway. Autonomous driving assistance is not necessarily executed when the vehicle travels in a section where the vehicle can travel autonomously (hereinafter referred to as an autonomous driving section), but is executed only when execution of autonomous driving assistance is selected by the user and in sections other than execution restricted sections. Even in the execution restricted sections, autonomous driving assistance is executed if the vehicle satisfies a condition (hereinafter referred to as the executable condition) according to the type of execution restricted section in which the vehicle is traveling. That is, the execution restricted sections are sections where autonomous driving assistance cannot be executed and sections where a predetermined condition must be satisfied in order to execute autonomous driving assistance.

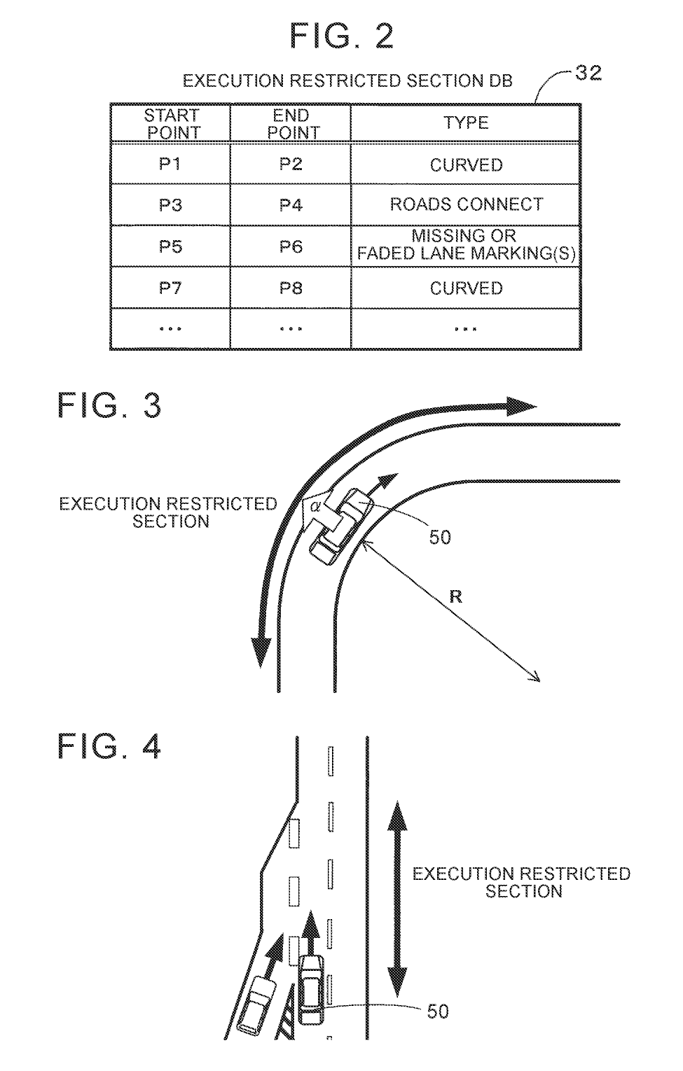

Regarding each execution restricted section that is present on the roads all over the country, the start point of the section, the end point of the section, and the type of execution restricted section are stored in the execution restricted section DB 32. FIG. 2 is a diagram showing an example of a storage area of the execution restricted section DB 32.

In the present embodiment, the following three types of sections are particularly defined as the execution restricted sections.

(A) Sections having a curved shape

(B) Sections where a plurality of roads connect

(C) Sections where a lane marking or markings are missing or have faded so much that a camera cannot recognize them

In the case where a vehicle 50 travels in any of “(A) sections having a curved shape,” the vehicle 50 is subjected to an outward centrifugal force a according to the vehicle speed and the radius of curvature R of the curve, as shown in FIG. 3. Accordingly, in order to appropriately move the vehicle in the section having a curved shape with autonomous driving assistance, the vehicle speed is required to be equal to or lower than the speed according to the radius of curvature R of the curve so that the centrifugal force a does not become large. Specifically, the “speed according to the radius of curvature R of the curve” is such a speed that the centrifugal force the vehicle is subjected to when traveling around the curve is equal to or lower than a threshold value. The smaller the radius of curvature of the curve is, the lower this speed is. That is, “(A) sections having a curved shape” are execution restricted sections where the executable condition that the speed of the vehicle is equal to or lower than the speed according to the radius of curvature of the curve must be satisfied in order to execute autonomous driving assistance.

In the case where the vehicle 50 travels in any of “(B) sections where a plurality of roads connect,” the vehicle 50 is required to behave flexibly according to the state of a traffic light or the movement of other traffic around the vehicle 50, and it is difficult for the vehicle 50 to travel with autonomous driving assistance. That is, “(B) sections where a plurality of roads connect” are execution restricted sections where autonomous driving assistance cannot be executed regardless of the state of the vehicle. In FIG. 4, a merging section where a road on which the vehicle 50 is traveling merges with another road is shown as an example of “(B) sections where a plurality of roads connect.” However, “(B) sections where a plurality of roads connect” also include branching sections where a road on which the vehicle 50 is traveling branches in a plurality of directions, intersections, etc.

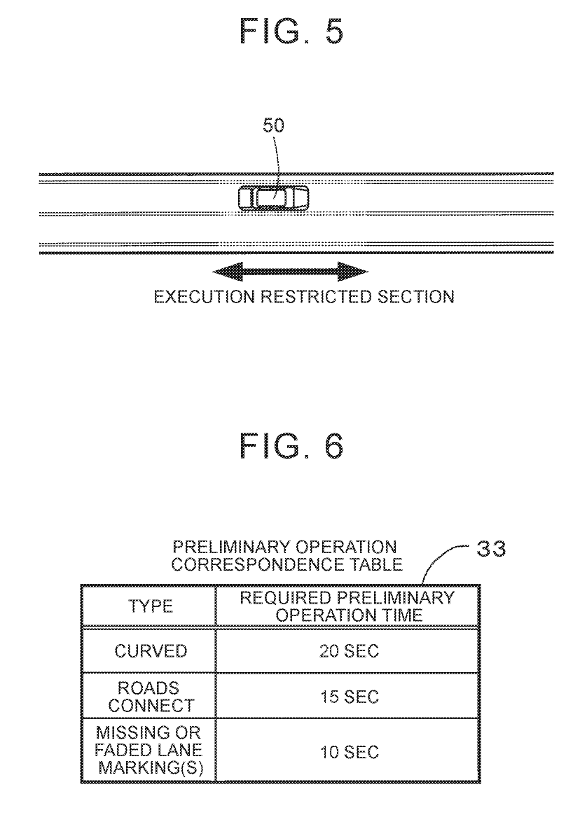

In the case where the vehicle 50 travels in any of “(C) sections where a lane marking or markings are missing or have faded so much that a camera cannot recognize them,” a lane marking or markings, which are road information required to execute autonomous driving assistance, cannot be recognized with the external camera 19 mounted on the vehicle 50, as shown in FIG. 5. If the speed of the vehicle 50 is low, a lane in which the vehicle 50 should travel cannot be recognized for a long time, and autonomous driving assistance cannot be executed. In order to move the vehicle with autonomous driving assistance, the vehicle speed must be a speed that satisfies the executable condition that the time for which a lane marking or markings cannot be recognized is allowable time (e.g., 3 seconds) or less. That is, “(C) sections where a lane marking or markings are missing or have faded so much that a camera cannot recognize them” are execution restricted sections where the executable condition that the time for which a lane marking or markings cannot be recognized is allowable time or less (i.e., the speed of the vehicle is equal to or higher than a predetermined speed) must be satisfied in order to execute autonomous driving assistance.

Information about the execution restricted sections stored in the execution restricted section DB 32 may be created based on map information or may be obtained from the external server such as a probe center. In particular, “(C) sections where a lane marking or markings are missing or have faded so much that a camera cannot recognize them” cannot be specified based on the map information, and therefore, are obtained from the external server or created based on lane marking detection history of the driver's vehicle.

The preliminary operation correspondence table 33 is a table that defines required preliminary operation time for each type of execution restricted section stored in the execution restricted section DB 32. The required preliminary operation time is the time required to prepare for traveling in an execution restricted section before the vehicle reaches the execution restricted section. FIG. 6 is a diagram showing an example of the preliminary operation correspondence table 33.

As shown in FIG. 6, the preliminary operation correspondence table 33 defines the required preliminary operation time for each type of execution restricted sections of (A) to (C) described above. In the case where the execution restricted section is a section where autonomous driving assistance cannot be executed regardless of the state of the vehicle (e.g., (B)), the required preliminary operation time is the time required to make a transition from traveling with autonomous driving assistance to manual driving based on vehicle occupant's driving maneuvers. In the case where the execution restricted section is a section where the executable condition must be satisfied in order to execute autonomous driving assistance (e.g., (A) or (C)), the required preliminary operation time is the time required to shift the state of the vehicle to the state that satisfies the executable condition. Accordingly, the required preliminary operation time is set to longer time as the executable condition for the type of execution restricted section is more stringent. Specifically, the required preliminary operation time is longer for “(A) sections having a curved shape” than for “(C) sections where a lane marking or markings are missing or have faded so much that a camera cannot recognize them.”

As described below, in the case where an execution restricted section is located ahead in the direction in which the vehicle is traveling, the navigation ECU 13 determines if the time required for the vehicle to reach the start point of the execution restricted section is equal to or less than the required preliminary operation time defined for this execution restricted section. If the time required for the vehicle to reach the start point of the execution restricted section is equal to or less than the required preliminary operation time, the navigation ECU 13 determines if autonomous driving assistance can be continued in the execution restricted section (that is, if the state of the vehicle satisfies the executable condition). If it is determined that the state of the vehicle does not satisfy the executable condition, the navigation ECU 13 controls the vehicle or prompts the user to shift the state of the vehicle to the state that satisfies the executable condition. If the execution restricted section located ahead in the direction in which the vehicle is traveling is a section where autonomous driving assistance cannot be executed regardless of the state of the vehicle, the navigation ECU 13 prompts the user to make a transition to manual driving at the timing the time required for the vehicle to reach the start point of the execution restricted section becomes equal to or less than the required preliminary operation time defined for this execution restricted section.

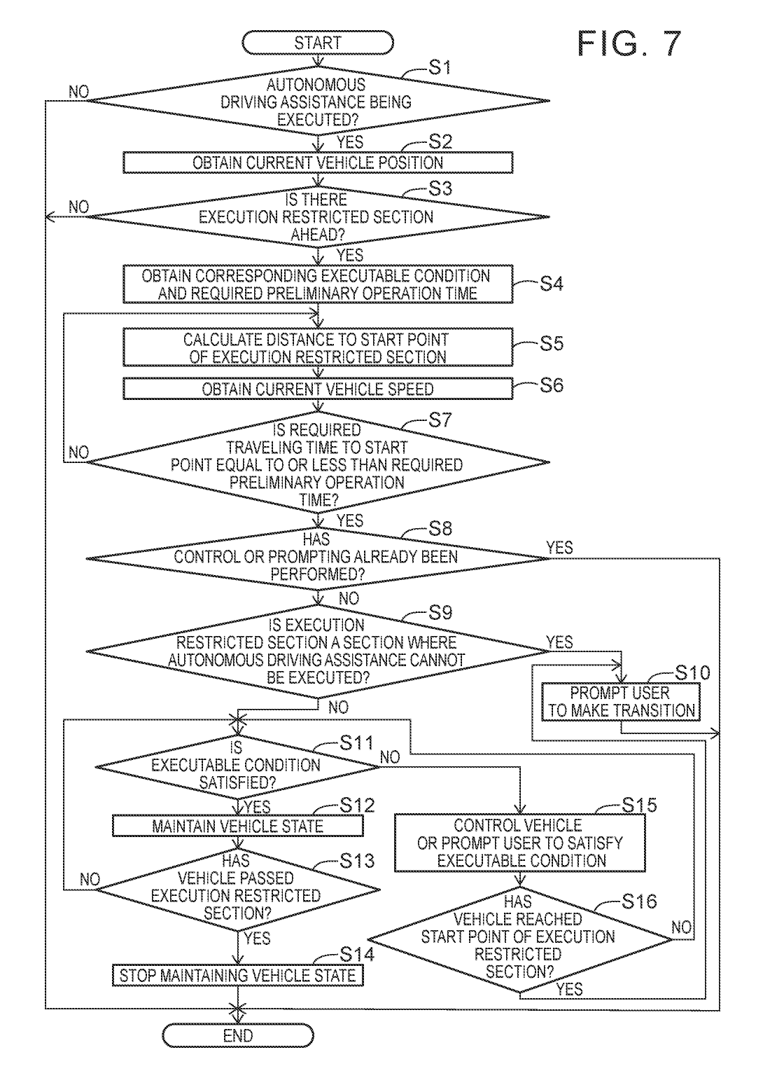

The navigation electronic control unit (ECU) 13 is an electronic control unit that generally controls the navigation system 1. The navigation ECU 13 includes: a CPU 41 serving as an arithmetic unit and a control unit; and internal storage devices such as a RAM 42 that is used as a working memory when the CPU 41 performs various arithmetic operations and that stores route data etc. when a route search is conducted, a ROM 43 having recorded thereon an autonomous driving assistance program (see FIG. 7) described below etc. in addition to a control program, and a flash memory 44 that stores a program read from the ROM 43. The navigation ECU 13 forms various means serving as processing algorithms. For example, section determining means determines if an execution restricted section where execution of autonomous driving assistance is restricted is located ahead in the direction in which the vehicle is traveling, when autonomous driving assistance is being executed in the vehicle. If it is determined that an execution restricted section is located ahead in the direction in which the vehicle is traveling, required preliminary operation time obtaining means obtains the required preliminary operation time that is set based on the type of the execution restricted section. Vehicle speed obtaining means obtains the speed of the vehicle. Required time determining means determines, based on the speed of the vehicle and the required preliminary operation time, if the time required for the vehicle to reach the start point of the execution restricted section is equal to or less than the required preliminary operation time. If it is determined that the time required for the vehicle to reach the start point of the execution restricted section is equal to or less than the required preliminary operation time, execution determining means determines if autonomous driving assistance can be continued in the execution restricted section. Control executing means controls the vehicle or prompts the user according to the determination result of the execution determining means.

The operation unit 14 is operated to enter a departure point as a travel start point and a destination as a travel end point etc. and is formed by a plurality of operation switches (not shown) such as various keys and buttons. The navigation ECU 13 performs control so as to execute various associated operations based on switch signals output in response to depression etc. of the switches. The operation unit 14 may be formed by a touch panel that is provided on the front surface of the liquid crystal display 15. Alternatively, the operation unit 14 may be formed by a microphone and a speech recognition device.

A map image including roads, traffic information, operation guidance, an operation menu, key guidance, guidance information on a guidance route (planned travel route), news, a weather forecast, time, emails, TV programs, etc. are displayed on the liquid crystal display 15. In particular, when an execution restricted section is approaching ahead of the vehicle, the user is informed of the position of the start point of the execution restricted section. Moreover, when the vehicle is located in the execution restricted section, the user is informed of the fact that the vehicle is located in the execution restricted section. An HUD or an HMD may be used instead of the liquid crystal di splay 15.

The speaker 16 outputs voice guidance for travel along the guidance route (planned travel route) and guidance of traffic information, based on a command from the navigation ECU 13. In particular, if an execution restricted section is approaching ahead of the vehicle and it is determined that the vehicle is not in the state that satisfies the executable condition for the execution restricted section, the speaker 16 outputs voice guidance prompting the user to shift the state of the vehicle to the state that satisfies the executable condition (e.g., “please slow down (speed up)” etc.). If it is determined that autonomous driving assistance cannot be executed, the speaker 16 outputs voice guidance prompting the user to make a transition to manual driving.

The DVD drive 17 is a drive that can read data recorded on a recording medium such as a DVD or a CD. The DVD drive 17 plays music or videos, updates the map information DB 31, etc. based on the read data. A card slot for reading and writing a memory card may be provided instead of the DVD drive 17.

The communication module 18 is a communication device that receives traffic information, probe information, weather information, etc. transmitted from a traffic information center such as, e.g., a VICS center or a probe center. For example, the communication module 18 is a mobile phone or a DCM. Other examples of the communication module 18 include a vehicle-to-vehicle communication device for communication between vehicles, and a roadside-to-vehicle communication device for communication between a vehicle and a roadside unit.

The external camera 19 is, e.g., a camera using a solid state imaging element such as a CCD. The external camera 19 is attached above a front bumper of the vehicle and is mounted such that its optical axis is tilted downward at a predetermined angle with respect to the horizontal direction. The external camera 19 captures an image of the road located ahead in the direction in which the vehicle is traveling, when the vehicle is traveling in an autonomous driving section. The vehicle control ECU 20 processes the captured image to detect road markings on the road on which the vehicle is traveling, other traffic around the vehicle, etc., and executes autonomous driving assistance of the vehicle based on the detection result. The external camera 19 may be placed on the rear or side part of the vehicle instead of on the front part of the vehicle. Instead of the camera, a sensor such as a millimeter wave radar, vehicle-to-vehicle communication, or roadside-to-vehicle communication may be used as means for detecting other traffic. An illuminance sensor or a rain sensor may be mounted as means for detecting other surrounding environments.

The vehicle control ECU 20 is an electronic control unit that controls the vehicle equipped with the navigation system 1. The vehicle control ECU 20 is connected to each driving part of the vehicle such as steering, a brake, and an accelerator. In the present embodiment, the vehicle control ECU 20 executes autonomous driving assistance of the vehicle by controlling each driving part particularly after autonomous driving assistance of the vehicle is started. When the user performs an override such as a steering operation or a brake operation during autonomous driving assistance, the vehicle control ECU 20 detects the override.

The navigation ECU 13 sends command signals regarding autonomous driving assistance to the vehicle control ECU 20 via a CAN after the vehicle starts to travel. The vehicle control ECU 20 executes autonomous driving assistance after the vehicle starts to travel, in response to the received command signals. The command signals contain information about the control of autonomous driving assistance (e.g., any of the controls (1) to (3)) to be executed for the vehicle and information instructing to start, stop, or change the control etc. Instead of the navigation ECU 13, the vehicle control ECU 20 may set the control of autonomous driving assistance. In that case, the vehicle control ECU 20 is configured to obtain information required to set the control of autonomous driving assistance, such as a planned travel route (guidance route), the state of the vehicle, and map information of surrounding areas, from the navigation system 1.

The autonomous driving assistance program that is executed by the CPU 41 in the navigation system 1 of the present embodiment having the above configuration will be described below based on FIG. 7. FIG. 7 is a flowchart of the autonomous driving assistance program according to the present embodiment. The autonomous driving assistance program is a program that is executed after an accessory power supply (ACC power supply) of the vehicle is turned on, and that performs control or prompts the user to continue autonomous driving assistance in the case where an execution restricted section is located ahead in the direction in which the vehicle is traveling. The program shown by the flowchart of FIG. 7 described below is stored in the RAM 42 or the ROM 43 of the navigation system 1 and is executed by the CPU 41.

In the autonomous driving assistance program, the CPU 41 first obtains, in step (hereinafter abbreviated as S) 1, the control state of autonomous driving assistance by communicating with the vehicle control ECU 20 via the CAN, and determines if the vehicle is executing any type of autonomous driving assistance. Autonomous driving assistance is executed in the situations where the user selects to execute autonomous driving assistance by operating the various operation buttons 21 mounted on the vehicle, such as the autonomous driving start button, and it is determined that the vehicle can travel with autonomous driving assistance. In particular, in the present embodiment, one or more of the controls (1) to (3) are performed as autonomous driving assistance according to the condition of the vehicle and the shape of the road on which the vehicle is traveling.

If it is determined that the vehicle is executing autonomous driving assistance (S1: YES), the routine proceeds to S2. If it is determined that the vehicle is not executing autonomous driving assistance (S1: NO), the autonomous driving assistance program is terminated.

In S2, the CPU 41 obtains the current position of the vehicle detected by the current position detection unit 11. It is desirable that the current position of the vehicle be specified in detail by using high accuracy location technology. The high accuracy location technology is technology that enables the lane in which a vehicle is traveling and the accurate position of the vehicle to be detected by detecting, by image recognition, white lines and road surface paint information obtained from a camera mounted on the vehicle and checking the white lines and the road surface paint information with a pre-stored map information DB. Since details of the high accuracy location technology are known in the art, description thereof will be omitted.

Subsequently, in S3, the CPU 41 determines if there is an execution restricted section within a predetermined distance (e.g., within 3 km) ahead in the direction in which the vehicle is traveling, based on the information specifying the start point and the end point of the execution restricted section stored in the execution restricted section DB 32 (FIG. 2). As described above, the execution restricted sections are sections where autonomous driving assistance cannot be executed or sections where a predetermined condition (executable condition) must be satisfied in order to execute autonomous driving assistance. In the present embodiment, the execution restricted sections particularly correspond to the sections (A) to (C) described above (see FIGS. 3 to 5).

If it is determined that there is an execution restricted section within the predetermined distance ahead in the direction in which the vehicle is traveling (S3: YES), the routine proceeds to S4. If it is determined that there is no execution restricted section within the predetermined distance ahead in the direction in which the vehicle is traveling (S3: NO), the autonomous driving assistance program is terminated.

In S4, regarding the execution restricted section determined to be present within the predetermined distance ahead in the direction in which the vehicle is traveling in S3, the CPU 41 obtains the executable condition that is set for this executable restricted section and the required preliminary operation time corresponding to the type of this executable restricted section.

Specifically, if the execution restricted section is “(A) a section having a curved shape,” the CPU 41 obtains the executable condition that “the speed of the vehicle is equal to or lower than the speed according to the radius of curvature of the curve.” The CPU 41 also obtains 20 seconds as the required preliminary operation time from the preliminary operation correspondence table 33 (FIG. 6).

If the execution restricted section is “(C) a section where a lane marking or markings are missing or have faded so much that a camera cannot recognize them,” the CPU 41 obtains the executable condition that “the time for which a lane marking or markings cannot be recognized is allowable time or less (that is, the speed of the vehicle is equal to or higher than a predetermined speed). The CPU 41 also obtains 10 seconds as the required preliminary operation time from the preliminary operation correspondence table 33 (FIG. 6).

If the execution restricted section is “(B) a section where a plurality of roads connect,” the CPU 41 does not obtain any executable condition because there is no executable condition for this type of sections. The CPU 41 obtains 15 seconds as the required preliminary operation time from the preliminary operation correspondence table 33 (FIG. 6).

In S5, the CPU 41 calculates the distance to the execution restricted section determined to be present ahead in the direction in which the vehicle is traveling, based on the current position of the vehicle obtained in S2. The position of the start point of the execution restricted section is obtained from the execution restricted section DB 32.

Subsequently, in S6, the CPU 41 obtains the current speed of the vehicle based on the detection result of the vehicle speed sensor 23.

Thereafter, in S7, the CPU 41 calculates the time t required for the vehicle to reach the start point of the execution restricted section (hereinafter referred to as the required traveling time) on the assumption that the vehicle continues to travel at the current vehicle speed V, based on the current vehicle speed V of the vehicle obtained in S6 and the distance L to the start point of the execution restricted section obtained in S5. The CPU 41 then determines if the calculated required traveling time t is equal to or less than the required preliminary operation time T obtained in S4. The CPU 41 may calculate the required traveling time t by predicting a change in vehicle speed which is caused by vehicle control or prompting described below, rather than based on the current vehicle speed V.

If it is determined that the required traveling time t is equal to or less than the required preliminary operation time T (S7: YES), the routine proceeds to S8. If it is determined that the required traveling time t is not equal to or less than the required preliminary operation time T (S7: NO), the routine returns to S5 and waits until the required traveling time t becomes equal to or less than the required preliminary operation time T.

In S8, the CPU 41 determines if vehicle control or prompting in S10, S12, or S15 described below has already been performed for the execution restricted section determined to be present within the predetermined distance ahead in the direction in which the vehicle is traveling.

If it is determined that vehicle control or prompting in S10, S12, or S15 described below has already been performed for the execution restricted section determined to be present within the predetermined distance ahead in the direction in which the vehicle is traveling (S8: YES), the autonomous driving assistance is terminated. If it is determined that vehicle control or prompting in S10, S12, or S15 described below has not been performed for the execution restricted section determined to be present within the predetermined distance ahead in the direction in which the vehicle is traveling (S8: NO), the routine proceeds to S9.

In S9, the CPU 41 determines if the execution restricted section determined to be present within the predetermined distance ahead in the direction in which the vehicle is traveling is an execution restricted section where autonomous driving assistance cannot be executed regardless of the state of the vehicle. In the present embodiment, “(B) sections where a plurality of roads connect” are the execution restricted sections where autonomous driving assistance cannot be executed regardless of the state of the vehicle.

If it is determined that the execution restricted section determined to be present within the predetermined distance ahead in the direction in which the vehicle is traveling is an execution restricted section where autonomous driving assistance cannot be executed regardless of the state of the vehicle (S9: YES), the routine proceeds to S10. If it is determined that the execution restricted section determined to be present within the predetermined distance ahead in the direction in which the vehicle is traveling is a section where an executable condition must be satisfied in order to execute autonomous driving assistance (S9: NO), the routine proceeds to S11.

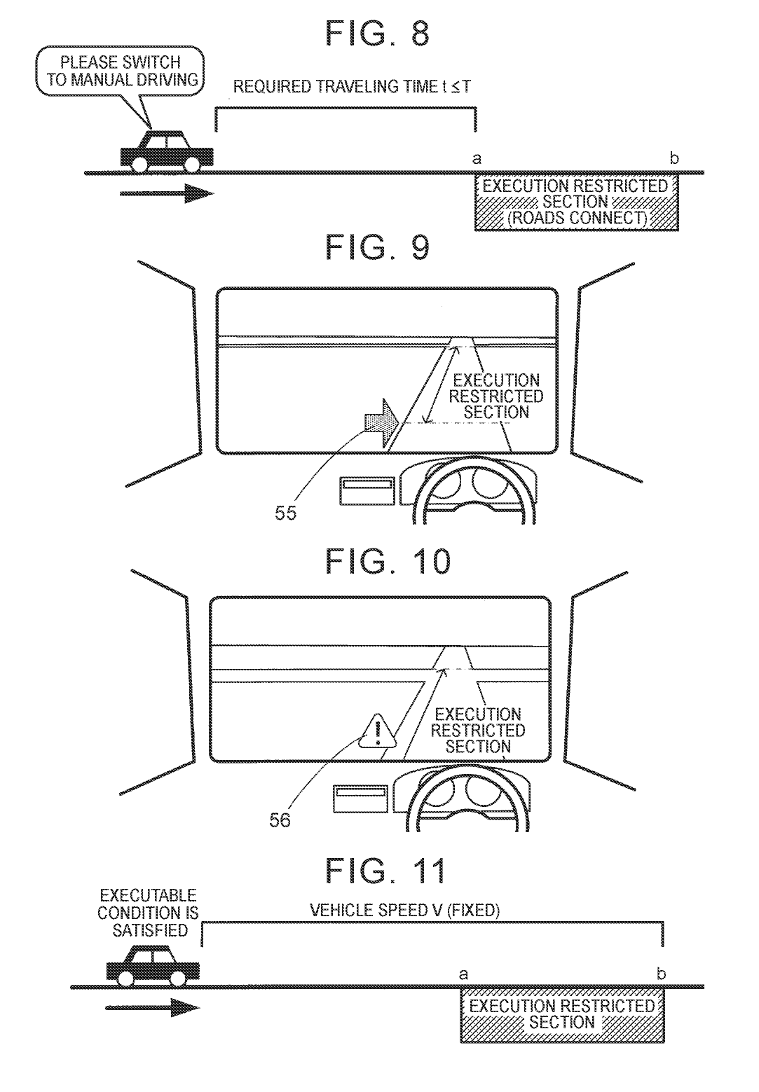

In S10, the CPU 41 determines that autonomous driving assistance cannot be continued, and prompts the user to make a transition from traveling with autonomous driving assistance to manual driving. For example, a voice output “please switch to manual driving” is generated. In the case where the execution restricted section determined to be present within the predetermined distance ahead in the direction in which the vehicle is traveling is an execution restricted section where autonomous driving assistance cannot be executed regardless of the state of the vehicle, the required preliminary operation time T set for this execution restricted section is the time required for the transition from traveling with autonomous driving assistance to manual driving. As shown in FIG. 8, the user is prompted to make a transition from traveling with autonomous driving assistance to manual driving at the time the required traveling time t required for the vehicle to reach the start point a of the execution restricted section becomes equal to or less than the time T required for the transition from traveling with autonomous driving assistance to manual driving. This allows the driver to appropriately make a transition from traveling with autonomous driving assistance to manual driving before the vehicle reaches the execution restricted section.

Subsequently, after the CPU 41 detects predetermined user's intention to start manual driving, the CPU 41 sends a command signal instructing to terminate autonomous driving assistance to switch to manual driving to the vehicle control ECU 20 via the CAN. As a result, autonomous driving assistance of the vehicle is completed and is switched to manual driving. The predetermined intention is an override operation or an operation of the autonomous driving start button. In S10, the CPU 41 merely prompts the user to make the transition. However, the CPU 41 may control the vehicle to make the transition. For example, the CPU 41 may decelerate the vehicle so as to facilitate the transition or may autonomously switch to manual driving.

It is desirable that the user be informed of the position of the start point of the execution restricted section from the time it is determined that there is an executable restricted section in the direction in which the vehicle is traveling until the vehicle reaches the execution restricted section. For example, as shown in FIG. 9, a virtual arrow 55 superimposed on the start point of the execution restricted section is generated by using a head-up display (HUD). This allows the user to easily know where the execution restricted section located ahead of the vehicle starts when he/she visually recognizes the environment ahead of the vehicle. Instead of the HUD, the liquid crystal display 15 or the speaker 16 may be used to inform the user of the position of the start point of the execution restricted section.

It is also desirable that, after the vehicle subsequently continues to travel and enters the execution restricted section, the user be informed of the fact that the vehicle is located in the execution restricted section, while the vehicle is located in the execution restricted section. For example, as shown in FIG. 10, a virtual warning sign 56 warning that the vehicle is located in the execution restricted section is generated by using the head-up display (HUD). This allows the user to easily know that the vehicle is currently traveling in the execution restricted section when he/she visually recognizes the environment ahead of the vehicle. Instead of the HUD, the liquid crystal display 15 or the speaker 16 may be used to inform the user of the fact that the vehicle is located in the execution restricted section.

In S11, the CPU 41 obtains the current state of the vehicle and determines if the current state of the vehicle satisfies the executable condition obtained in S4, namely if autonomous driving assistance can be continued in the execution restricted section even if the current state of the vehicle is maintained.

If it is determined that the current state of the vehicle satisfies the executable condition obtained in S4 (S11: YES), it means that, if the current state of the vehicle is maintained, autonomous driving assistance can be continued even in the execution restricted section located ahead in the direction in which the vehicle is traveling. Accordingly, the current state of the vehicle (specifically, the speed of the vehicle) is maintained to continue traveling with autonomous driving assistance (S12). The routine then proceeds to S13.

If it is determined that the current state of the vehicle does not satisfy the executable condition obtained in S4 (S11: NO), namely if autonomous driving assistance cannot be executed in the execution restricted section if the current state of the vehicle is maintained, the routine proceeds to S15.

In S13, the CPU 41 determines if the vehicle has passed the end point of the execution restricted section. The CPU 41 obtains the position of the end point of the execution restricted section from the execution restricted section DB 32.

If it is determined that the vehicle has passed the end point of the execution restricted section (S13: YES), the routine proceeds to S14. If it is determined that the vehicle has not passed the end point of the execution restricted section (S13: NO), the routine returns to S11.

In S14, the CPU 41 stops maintaining the state of the vehicle (specifically, the speed of the vehicle) started in S12. That is, as shown in FIG. 11, the state of the vehicle is maintained from the time it is determined in S11 that the state of the vehicle satisfies the executable condition until the vehicle passes the end point b of the execution restricted section. Thereafter, the vehicle travels with normal autonomous driving assistance.

In S15, the CPU 41 controls the vehicle or prompts the user to shift the state of the vehicle to the state that satisfies the executable condition obtained in S4.

Specifically, in the case where the execution restricted section located ahead in the direction in which the vehicle is traveling is “(A) a section having a curved shape,” the CPU 41 outputs a command signal to the vehicle control ECU 20 to perform deceleration control of the vehicle in order to satisfy the condition that the speed of the vehicle is equal to or lower than the speed according to the radius of curvature of the curve. The CPU 41 may prompt the user to slow down, rather than performing deceleration control of the vehicle. For example, a voice output “please slow down” is generated. In the case where the CPU 41 prompts the user to slow down instead of controlling the vehicle, autonomous driving assistance is required not to be cancelled by user's brake operation.

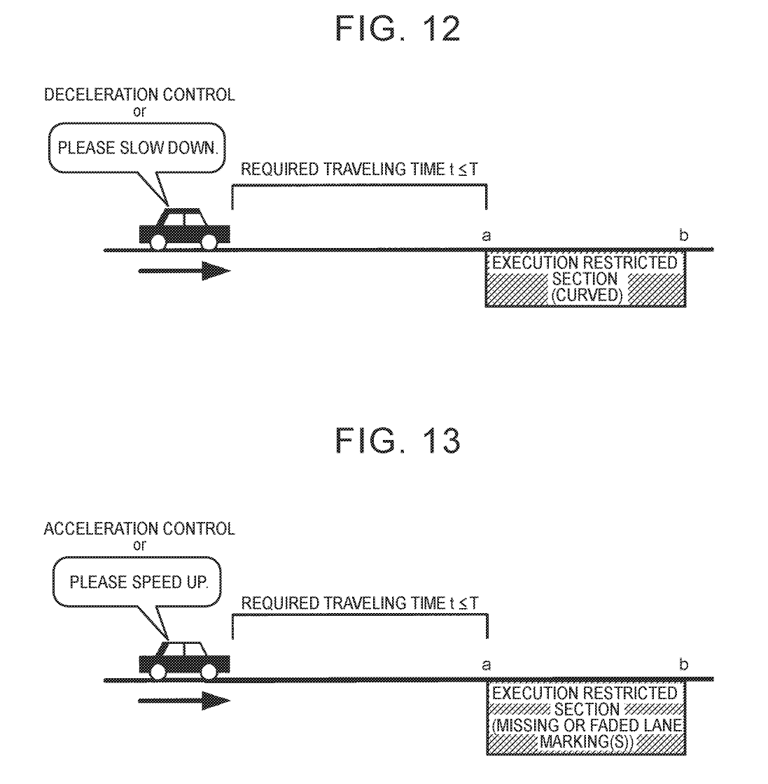

In the case where the execution restricted section determined to be located within the predetermined distance ahead in the direction in which the vehicle is traveling is an execution restricted section where an executable condition must be satisfied in order to execute autonomous driving assistance, the required preliminary operation time T that is set for this execution restricted section is the time required to shift the state of the vehicle to the state that satisfies the executable condition. Accordingly, as shown in FIG. 12, the CPU 41 performs deceleration control of the vehicle or prompts the user to slow down at the time the required traveling time t required for the vehicle to reach the start point a of the execution restricted section becomes equal to or less than the time T required to reduce the speed of the vehicle to a speed equal to or lower than the speed according to the radius of curvature of the curve. Through the vehicle control performed in S15 or user's vehicle maneuvers carried out as prompted in S15, the state of the vehicle can be shifted to the state that satisfies the executable condition, by the time the vehicle reaches the start point a of the execution restricted section. Autonomous driving assistance can be continued if the vehicle subsequently satisfies the executable condition by the time the vehicle reaches the start point a of the execution restricted section.

In the case where the execution restricted section located ahead in the direction in which the vehicle is traveling is “(C) a section where a lane marking or markings are missing or have faded so much that a camera cannot recognize them,” the CPU 41 outputs a command signal to the vehicle control ECU 20 to perform acceleration control of the vehicle in order to satisfy the condition that the time for which a lane marking or markings cannot be recognized is allowable time or less (i.e., the speed of the vehicle is equal to or higher than a predetermined speed). The CPU 41 may prompt the user to speed up, rather than performing acceleration control of the vehicle. For example, a voice output “please speed up” is generated. In the case where the CPU 41 prompts the user to speed up instead of controlling the vehicle, autonomous driving assistance is required not to be cancelled by user's accelerator operation.

In the case where the execution restricted section determined to be located within the predetermined distance ahead in the direction in which the vehicle is traveling is an execution restricted section where an executable condition must be satisfied in order to execute autonomous driving assistance, the required preliminary operation time T that is set for this execution restricted section is the time required to shift the state of the vehicle to the state that satisfies the executable condition. Accordingly, as shown in FIG. 13, the CPU 41 performs acceleration control of the vehicle or prompts the user to speed up at the time the required traveling time t required for the vehicle to reach the start point a of the execution restricted section becomes equal to or less than the time T required to make the time for which a lane marking or markings cannot be recognized equal to or less than the allowable time (i.e., to make the speed of the vehicle equal to or higher than the predetermined speed). Through the vehicle control performed in S15 or user's vehicle maneuvers carried out as prompted in S15, the state of the vehicle can be shifted to the state that satisfies the executable condition, by the time the vehicle reaches the start point a of the execution restricted section. Autonomous driving assistance can be continued if the vehicle subsequently satisfies the executable condition by the time the vehicle reaches the start point a of the execution restricted section.

Subsequently, in S16, the CPU 41 determines if the vehicle has reached the start point of the execution restricted section. The CPU 41 obtains the position of the start point of the execution restricted section from the execution restricted section DB 32.

If it is determined that the vehicle has reached the start point of the execution restricted section (S16: NO), the routine proceeds to S11. In S11, the CPU 41 determines if the state of the vehicle has been shifted to the state that satisfies the executable condition obtained in S4 by the vehicle control or prompting in S15. If it is determined that the current state of the vehicle satisfies the executable condition (S11: YES), the routine proceeds to S12 and the state of the vehicle is maintained (i.e., the vehicle is not accelerated or decelerated any more). If it is determined again that the state of the vehicle does not satisfy the executable condition obtained in S4 (S11: NO), the vehicle control or prompting is continued until the executable condition is satisfied (S15).

If it is determined that the vehicle reaches the start point of the execution restricted section before the vehicle satisfies the executable condition (S16: YES), the routine proceeds to S10. In S10, the CPU 41 prompts the user to make a transition from traveling with autonomous driving assistance to manual driving, as described above (see FIG. 8). Accordingly, if, despite the vehicle control or prompting, the vehicle was not able to satisfy the executable condition by the time the vehicle reaches the execution restricted section, autonomous driving assistance of the vehicle is terminated, and the vehicle is switched to manual driving. In S16, the CPU 41 may prompt the user to make the transition a predetermined time before the vehicle reaches the start point of the execution restricted section, rather than when the vehicle has reached the start point of the execution restricted section, in order to allow for the time for the vehicle to make the transition.

As described in detail above, in the navigation system 1 according to the present embodiment, the autonomous driving assistance method that is performed by the navigation system 1, and the computer program that is executed by the navigation system 1, when autonomous driving assistance is being executed in the vehicle, it is determined if an execution restricted section where execution of autonomous driving assistance is restricted is located ahead in the direction in which the vehicle is traveling (S3). If it is determined that an execution restricted section is located ahead in the direction in which the vehicle is traveling, the required preliminary operation time that is set based on the type of the execution restricted section is obtained (S4). If it is determined that the time required for the vehicle to reach the start point of the execution restricted section is equal to or less than the required preliminary operation time, it is determined if autonomous driving assistance can be continued in the execution restricted section (S9, S11), and the vehicle is controlled or the user is prompted according to the determination result (S10, S12, S14, S15). Accordingly, even if an execution restricted section where execution of autonomous driving assistance is restricted is located ahead in the direction in which the vehicle is traveling, the vehicle is controlled or the user is prompted according to the current state of the vehicle at such a timing that allows necessary and sufficient time before the vehicle reaches the execution restricted section. Accordingly, by the time the vehicle reaches the execution restricted section, the state of the vehicle can be shifted to the state where autonomous driving assistance can be executed. As a result, autonomous driving assistance can be continued as long as possible.

It should be understood that the above exemplary embodiment is an example and various improvements and modifications can be made without departing from the spirit and scope.

For example, in the embodiment, the sections (A) to (C) are shown as the execution restricted sections where execution of autonomous driving assistance is restricted. However, the execution restricted sections may be sections other than the sections (A) to (C). For example, the execution restricted sections may be sections where road information required to execute autonomous driving assistance, other than lane markings, cannot be obtained, sections where the gradient is a predetermined angle or more, merging sections where a lane merges another lane, sections with a traffic jam, etc. In the embodiment, the executable conditions are the conditions regarding the speed of the vehicle. However, the executable conditions may be other conditions. For example, the executable conditions may be conditions regarding the distance to a vehicle ahead, acceleration, angular velocity, etc.

In the embodiment, the execution restricted sections are sections where execution of all functions of autonomous driving assistance is restricted. However, the execution restricted sections may be sections where execution of a part of the functions of the autonomous driving assistance is restricted. For example, the execution restricted sections may be sections where execution of “constant speed cruising” and “adaptive cruising” is restricted but “lane keeping” may be continuously executed even if an executable condition is not satisfied.

In the embodiment, whether autonomous driving assistance can be continued in an execution restricted section or not is determined if it is determined that the time required for the vehicle to reach the start point of the execution restricted section is equal to or less than the required preliminary operation time (S7: YES). However, whether autonomous driving assistance can be continued in an execution restricted section or not may be determined when the distance from the current position of the vehicle to the start point of the execution restricted section is equal to or shorter than a predetermined distance. The predetermined distance is the distance from the position where the time required for the vehicle to reach the start point of the execution restricted section becomes equal to the required preliminary operation time to the start point of the execution restricted section.

In the embodiment, the user manually makes lane changes even when autonomous driving assistance is being executed. However, lane changes may be autonomously made with autonomous driving assistance. Making right and left turns, stopping, starting, etc. may also be autonomously performed with autonomous driving assistance.

In the embodiment, controlling all of an accelerator operation, a brake operation, and a steering wheel operation, which are maneuvers related to the vehicle behavior out of vehicle maneuvers, by the vehicle control ECU 20 is described as autonomous driving assistance that is executed so that the vehicle travels autonomously without user's driving maneuvers. In the autonomous driving assistance, however, the vehicle control ECU 20 may control at least one of the accelerator operation, the brake operation, and the steering wheel operation, which are the maneuvers related to the vehicle behavior out of the vehicle maneuvers. Manual driving based on user's driving maneuvers is described as the user performing all of the accelerator operation, the brake operation, and the steering wheel operation, which are the maneuvers related to the vehicle behavior out of the vehicle maneuvers.

In the embodiment, the navigation system 1 executes the autonomous driving assistance program (FIG. 7). However, the vehicle control ECU 20 may execute the autonomous driving assistance program. In that case, the vehicle control ECU 20 obtains the current position of the vehicle, map information, traffic information, etc. from the navigation system 1.

The above described principles are applicable to devices having a traveling guidance function, in addition to the navigation system 1. For example, the embodiments may employ mobile phones, smartphones, tablet computers, personal computers, etc. (hereinafter referred to as the “mobile terminals etc.”). Systems formed by a server and a mobile terminal etc. can also be used. In that case, each step of the above autonomous driving assistance program (FIG. 7) may be performed by either the server or the mobile terminal etc. In the case where a mobile terminal etc. is used, a vehicle capable of executing autonomous driving assistance and the mobile terminal etc. need to be connected (either wired or wireless) so that they can communicate with each other.

Although the embodiment of the autonomous driving assistance system is described above, the autonomous driving assistance system may have the following configurations. In that case, the autonomous driving assistance system has the following effects.

For example, a first configuration is as follows.

An autonomous driving assistance system includes: section determining means for determining if an execution restricted section where execution of autonomous driving assistance is restricted is located ahead in a direction in which a vehicle is traveling, when autonomous driving assistance is being executed in the vehicle; required preliminary operation time obtaining means for obtaining, if it is determined by the section determining means that the execution restricted section is located ahead in the direction in which the vehicle is traveling, required preliminary operation time that is set based on a type of the execution restricted section; vehicle speed obtaining means for obtaining a speed of the vehicle; required time determining means for determining, based on the speed of the vehicle and the required preliminary operation time, if time required for the vehicle to reach a start point of the execution restricted section is equal to or less than the required preliminary operation time; execution determining means for determining, if it is determined that the time required for the vehicle to reach the start point of the execution restricted section is equal to or less than the required preliminary operation time, if a state of the vehicle satisfies an executable condition, which is a condition under which autonomous driving assistance can be continued, in the execution restricted section; and control executing means for controlling the vehicle or prompting a user to shift the state of the vehicle to a state that satisfies the executable condition, if it is determined that the state of the vehicle does not satisfy the executable condition in the execution restricted section.

According to the autonomous driving assistance system having the above configuration, even if an execution restricted section where execution of autonomous driving assistance is restricted is located ahead in the direction in which the vehicle is traveling, the vehicle is controlled or the user is prompted according to the current state of the vehicle at such a timing that allows necessary and sufficient time before the vehicle reaches the execution restricted section. Accordingly, by the time the vehicle reaches the execution restricted section, the state of the vehicle can be shifted to the state where autonomous driving assistance can be executed. As a result, autonomous driving assistance can be continued as long as possible.

A second configuration is as follows.

The execution restricted section is either a section where autonomous driving assistance cannot be executed or a section where the state of the vehicle must satisfy the executable condition in order to execute autonomous driving assistance.

According to the autonomous driving assistance system having the above configuration, the section where autonomous driving assistance cannot be executed or the section where the state of the vehicle must satisfy the executable condition in order to execute autonomous driving assistance can be set as the execution restricted section.

A third configuration is as follows.

The execution restricted section is the section where the state of the vehicle must satisfy the executable condition in order to execute autonomous driving assistance. The executable condition varies depending on the type of the execution restricted section. The required preliminary operation time is set to longer time as the executable condition for the type of the execution restricted section is more stringent.

According to the autonomous driving assistance system having the above configuration, regarding the execution restricted section where the state of the vehicle must satisfy the executable condition in order to execute autonomous driving assistance, the required preliminary operation time can be appropriately set to time required to shift the state of the vehicle to the state that satisfies the executable condition. As a result, by controlling the vehicle or prompting the user, the state of the vehicle can be shifted to the state where autonomous driving assistance can be executed, by the time the vehicle reaches the execution restricted section.

A fourth configuration is as follows.

The execution restricted section is any of a section having a curved shape, a section where a plurality of roads connect, and a section where a lane marking is missing or has faded so much that a camera cannot recognize the lane marking.

According to the autonomous driving assistance system having the above configuration, the section where autonomous driving assistance cannot be executed or the section where the state of the vehicle must satisfy the executable condition in order to execute autonomous driving assistance can be set as the execution restricted section.

A fifth configuration is as follows.

The autonomous driving assistance system further includes: start point informing means for informing the user of a position of the start point of the execution restricted section until the vehicle reaches the execution restricted section.

According to the autonomous driving assistance system having the above configuration, the user can accurately know in advance where the execution restricted section starts. This allows the user to appropriately recognize when to terminate the vehicle control or when to make a transition to manual driving as informed by the start point informing means.

A sixth configuration is as follows.

The autonomous driving assistance system further includes: section informing means for informing the user of a fact that the vehicle is located in the execution restricted section, while the vehicle is located in the execution restricted section.

According to the autonomous driving assistance system having the above configuration, the user can know that the vehicle is traveling in the execution restricted section. This allows the user to appropriately recognize that the vehicle is located in the section where execution of autonomous driving assistance is restricted.

A seventh configuration is as follows.

The required preliminary operation time is time required to make a transition from traveling with autonomous driving assistance to manual driving based on a vehicle occupant's driving maneuver.

According to the autonomous driving assistance system having the above configuration, even if autonomous driving assistance cannot be executed in the execution restricted section, the vehicle is controlled or the user is prompted at such a timing that allows time necessary and sufficient to make the transition to manual driving by the time the vehicle reaches the execution restricted section. Accordingly, the transition to manual driving can be made appropriately.

An eighth configuration is as follows.

The control executing means controls the vehicle or prompts the user to make a transition from traveling with autonomous driving assistance to manual driving, if it is determined that the state of the vehicle does not satisfy the executable condition in the execution restricted section.

According to the autonomous driving assistance system having the above configuration, if it is determined that autonomous driving assistance cannot be executed in the execution restricted section, the vehicle is controlled or the user is prompted to make the transition to manual driving at such a timing that allows time necessary and sufficient to make the transition by the time the vehicle reaches the execution restricted section. Accordingly, the transition to manual driving can be made appropriately by the time the vehicle reaches the execution restricted section.

1. An autonomous driving assistance system, comprising:
a processor programmed to:
determine if an execution restricted section where execution of autonomous driving assistance is restricted is located ahead in a direction in which a vehicle is traveling, when autonomous driving assistance is being executed in the vehicle;
obtain, if it is determined that the execution restricted section is located ahead in the direction in which the vehicle is traveling, required preliminary operation time that is set based on a type of the execution restricted section;
obtain a speed of the vehicle;
determine, based on the speed of the vehicle and the required preliminary operation time, if time required for the vehicle to reach a start point of the execution restricted section is equal to or less than the required preliminary operation time;
determine, if it is determined that the time required for the vehicle to reach the start point of the execution restricted section is equal to or less than the required preliminary operation time, if a state of the vehicle satisfies an executable condition, which is a condition under which autonomous driving assistance can be continued, in the execution restricted section; and
control the vehicle or prompt a user to shift the state of the vehicle to a state that satisfies the executable condition, if it is determined that the state of the vehicle does not satisfy the executable condition in the execution restricted section.

2. The autonomous driving assistance system according to claim 1, wherein:
the execution restricted section is either a section where autonomous driving assistance cannot be executed or a section where the state of the vehicle must satisfy the executable condition in order to execute autonomous driving assistance.

3. The autonomous driving assistance system according to claim 2, wherein:
the execution restricted section is the section where the state of the vehicle must satisfy the executable condition in order to execute autonomous driving assistance;
the executable condition varies depending on the type of the execution restricted section; and
the required preliminary operation time is set to longer time as the executable condition for the type of the execution restricted section is more stringent.

4. The autonomous driving assistance system according to claim 1, wherein:
the execution restricted section is any of a section having a curved shape, a section where a plurality of roads connect, and a section where a lane marking is missing or has faded so much that a camera cannot recognize the lane marking.

5. The autonomous driving assistance system according to claim 1, wherein the processor is programmed to:
inform the user of a position of the start point of the execution restricted section until the vehicle reaches the execution restricted section.

6. The autonomous driving assistance system according to claim 1, wherein the processor is programmed to:
inform the user of a fact that the vehicle is located in the execution restricted section, while the vehicle is located in the execution restricted section.

7. The autonomous driving assistance system according to claim 1, wherein:
the required preliminary operation time is time required to make a transition from traveling with autonomous driving assistance to manual driving based on a vehicle occupant's driving maneuver.

8. The autonomous driving assistance system according to claim 1, wherein the processor is programmed to:
control the vehicle or prompt the user to make a transition from traveling with autonomous driving assistance to manual driving, if it is determined that the state of the vehicle does not satisfy the executable condition in the execution restricted section.

9. An autonomous driving assistance method, comprising:
determining if an execution restricted section where execution of autonomous driving assistance is restricted is located ahead in a direction in which a vehicle is traveling, when autonomous driving assistance is being executed in the vehicle;
if it is determined that the execution restricted section is located ahead in the direction in which the vehicle is traveling, obtaining, required preliminary operation time that is set based on a type of the execution restricted section;
obtaining a speed of the vehicle;
determining if time required for the vehicle to reach a start point of the execution restricted section is equal to or less than the required preliminary operation time, based on the speed of the vehicle and the required preliminary operation time;
if it is determined that the time required for the vehicle to reach the start point of the execution restricted section is equal to or less than the required preliminary operation time, determining if a state of the vehicle satisfies an executable condition, which is a condition under which autonomous driving assistance can be continued, in the execution restricted section; and
if it is determined that the state of the vehicle does not satisfy the executable condition in the execution restricted section, controlling the vehicle or prompting a user to shift the state of the vehicle to a state that satisfies the executable condition.

10. A computer-readable storage medium storing a computer-executable program that causes a computer to perform the following functions:
determining if an execution restricted section where execution of autonomous driving assistance is restricted is located ahead in a direction in which a vehicle is traveling, when autonomous driving assistance is being executed in the vehicle;
obtaining, if it is determined that the execution restricted section is located ahead in the direction in which the vehicle is traveling, required preliminary operation time that is set based on a type of the execution restricted section;
obtaining a speed of the vehicle;
determining, based on the speed of the vehicle and the required preliminary operation time, if time required for the vehicle to reach a start point of the execution restricted section is equal to or less than the required preliminary operation time;
determining, if it is determined that the time required for the vehicle to reach the start point of the execution restricted section is equal to or less than the required preliminary operation time, if a state of the vehicle satisfies an executable condition, which is a condition under which autonomous driving assistance can be continued, in the execution restricted section; and
controlling the vehicle or prompting a user to shift the state of the vehicle to a state that satisfies the executable condition, if it is determined that the state of the vehicle does not satisfy the executable condition in the execution restricted section.
